(19) United States
(12) Patent Application Publication
(10) Pub. No.: US 2008/0053001 A1
(43) Pub. Date: Mar. 6, 2008

(54) Polishing Composition and Polishing Method

(75) Inventors: Naoto Noguchi, Ichinomiya-shi (JP); Kazutoshi Kotama, Toyota-shi (JP); Yutaka Niwano, Kounan-shi (JP)

Correspondence Address: VIDAS, ARRETT & STEINKRAUS, P.A., SUITE 400, 6640 SHADY OAK ROAD, EDEN PRAIRIE, MN, 55344, US

(73) Assignee: FUJIMI INCORPORATED, Kiyosu-shi (JP)

(21) Appl. No.: 11/844,647

(22) Filed: Aug. 24, 2007

(30) Foreign Application Priority Data
Aug. 24, 2006 (JP) 2006-227613

(51) Int. Cl. C09K 3/14

(52) U.S. Cl. 51/298; 51/307

(57) ABSTRACT

In a polishing composition, the concentration of one of either sodium ions or acetate ions is 10 ppb or less, or the concentrations of sodium ions and acetate ions are 10 ppb or less. The polishing composition preferably contains a water soluble polymer such as hydroxyethylcellulose, an alkali such as ammonia, and abrasive grains such as colloidal silica. The polishing composition is mainly used in polishing of the surfaces of semiconductor wafers such as silicon wafers, especially used in finish polishing of the surfaces of such wafers.

### BACKGROUND OF THE INVENTION

The present invention relates to a polishing composition mainly used in polishing of a semiconductor wafer and to a method of polishing using the polishing composition.

Generally, polishing of a semiconductor wafer such as a silicon wafer is performed in two stages divided into preliminary polishing and finish polishing. As polishing compositions usable in finish polishing, known are, for example, polishing compositions described in Japanese Laid-Open Patent Publication No. 02-158684 and Japanese Laid-Open Patent Publication No. 03-202269. The polishing composition of Japanese Laid-Open Patent Publication No. 02-158684 contains water, colloidal silica, a water soluble polymer such as polyacrylamide and sizofuran, and a water soluble salt such as potassium chloride. The polishing composition of Japanese Laid-Open Patent Publication No. 03-202269 contains colloidal silica wherein the total content of sodium and other metals is in the range of 0-200 ppm, a bactericide, and a biocide.

At present, regarding LPDs (light point defects) that are a kind of defect observed on the surface of a wafer after being polished with a polishing composition, reducing those with a size of 65 nm or more is required due to their effect on performance of a semiconductor device. In this regard, it is difficult to reduce the number of LPDs, even using the polishing compositions of the above JP Publications, compared with conventional ones.

### SUMMARY OF THE INVENTION

Accordingly, an object of the present invention is to provide a polishing composition, by using which the number of LPDs with a size of 65 nm or more can be reduced on the surface of a physical object after being polished, and a method of polishing using the polishing composition.

In accordance with a first aspect of the present invention, a polishing composition is provided. The concentration of one of either sodium ions or acetate ions in the polishing composition is 10 ppb or less.

In accordance with a second aspect of the present invention, another polishing composition is provided. The concentrations of sodium ions and acetate ions in the polishing composition are 10 ppb or less.

In accordance with a third aspect of the present invention, a method of polishing is provided. The method includes polishing a surface of a semiconductor wafer using either one of the above polishing compositions.

Other aspects and advantages of the invention will become apparent from the following description, illustrating by way of example the principles of the invention.

### DETAILED DESCRIPTION OF THE PREFERRED EMBODIMENTS

An embodiment of the present invention will be described hereafter.

A polishing composition according to the present embodiment is produced by mixing predetermined amounts of a water soluble polymer, an alkali, and abrasive grains with water. Thus, the polishing composition of the present embodiment substantially consists of a water soluble polymer, an alkali, abrasive grains, and water. This polishing composition is used in polishing of semiconductor wafers such as silicon wafers, especially used in finish polishing of such wafers.

The polishing composition of the present embodiment is essentially required to contain sodium ions and acetate ions, respectively, in a concentration of 10 ppb or less. Sodium ions and acetate ions in the polishing composition come from impurities contained in the water soluble polymer, alkali, abrasive grains, and water. This includes sodium ions and acetate ions from a sodium compound and an acetate compound which are used in synthesizing the water soluble polymer as well as sodium ions generated in synthesizing silica in the case where the abrasive grains contain silica.

When the concentration of sodium ions or acetate ions in a polishing composition is higher than 10 ppb, it is difficult to reduce the number of LPDs with a size of 65 nm or more on the surface of a wafer after being polished with the polishing composition. It is assumed that sodium ions and acetate ions in a polishing composition are electrically adsorbed on the surface of a wafer, which is the object of polishing, or the surface of abrasive grains in the polishing composition, and as a result, the electric double layer on the surface of the wafer or abrasive grains become unstable. More specifically, it may be thought that sodium ions and acetate ions in a polishing composition act to weaken electric repulsion between the surface of a wafer and the surface of abrasive grains both of which are negatively charged. Thus, as the concentration of sodium ions or acetate ions in a polishing composition is higher, abrasive grains are more liable to adhere to the surface of a wafer, so that the occurrence of defects on the surface of the wafer is facilitated. In this regard, when the concentrations of sodium ions and acetate ions in a polishing composition are 10 ppb or less, the occurrence of such defects on the surface of a wafer due to sodium ions and acetate ions in the polishing composition is strongly suppressed, leading to the reduction of the number of LPDs with a size of 65 nm or more on the surface of the wafer.

In order to bring the concentrations of sodium ions and acetate ions in a polishing composition to 10 ppb or less, it is preferred to use highly pure materials containing impurities in an amount as low as possible when producing the polishing composition. When a highly pure material is commercially available, for example, as in the case of an alkali, it may be used, or alternatively, when the synthesis of a highly pure material is possible, the synthesized one may be used. When many impurities are contained in a raw material, it is preferable that the raw material should be used for producing a polishing composition, following the removal of the impurities beforehand. The removal of impurities contained in a water soluble polymer is possible, for example, by washing or ion exchange. The removal of impurities contained in an alkali is possible, for example, by ion exchange or the adsorption with a chelate resin. The removal of impurities contained in abrasive grains is possible, for example, by washing or ion exchange.

A water soluble polymer contained in the polishing composition of the present embodiment is preferably a water soluble cellulose or vinyl polymer, from the view point to reduce haze that is a sort of defect observed on the surface of a wafer after being polished with the polishing composition. Specific examples of water soluble celluloses include hydroxymethylcellulose, hydroxyethylcellulose, hydroxypropylcellulose, carboxymethylcellulose, and the like. Specific examples of vinyl polymers include polyvinyl alcohol, polyvinylpyrrolidone, and the like. It is presumed that these water soluble polymers form a hydrophilic membrane on the surface of a wafer, which membrane acts to reduce haze.

In the case where a water soluble polymer contained in a polishing composition is hydroxyethylcellulose or polyvinyl alcohol, more specifically, hydroxyethylcellulose, haze observed on the surface of a wafer after being polished with the polishing composition is more remarkably reduced compared with the case in which other water soluble polymer is used. Therefore, a water soluble polymer contained in a polishing composition is preferably hydroxyethylcellulose or polyvinyl alcohol, and more preferably hydroxyethylcellulose.

The content of a water soluble polymer in a polishing composition is preferably 0.01 g/L or more, more preferably 0.03 g/L or more, and still more preferably 0.05 g/L or more. As the higher content of a water soluble polymer facilitates the formation of a hydrophilic membrane which is effective for reducing haze on the surface of a wafer, haze observed on the surface of the wafer after being polished with a polishing composition is reduced. In this regard, when the content of a water soluble polymer in a polishing composition is 0.01 g/L or more, more specifically 0.03 g/L or more, and still more specifically 0.05 g/L or more, haze observed on the surface of a wafer after being polished with the polishing composition is reduced to an especially preferable level for practical use.

The content of a water soluble polymer in a polishing composition is preferably 2 g/L or less, more preferably 0.5 g/L or less, and still more preferably 0.2 g/L or less. A hydrophilic membrane of a water soluble polymer causes the decrease of the rate of polishing (rate of removing) a wafer by a polishing composition. As a result, as the content of a water soluble polymer in a polishing composition is decreased, the reduction of polishing rate due to a hydrophilic membrane is suppressed. In this regard, when the content of a water soluble polymer in a polishing composition is 2 g/L or less, more specifically 0.5 g/L or less, still more specifically 0.2 g/L or less, the reduction of polishing rate due to a hydrophilic membrane is suppressed to an especially preferable level for practical use.

In the case where a water soluble polymer contained in a polishing composition is a water soluble cellulose, the average molecular weight of the water soluble cellulose used is preferably 300,000 or more, more preferably 600,000 or more, and still more preferably 900,000 or more. On the other hand, in the case where a water soluble polymer contained in a polishing composition is a vinyl polymer, the average molecular weight of the vinyl polymer used is preferably 1,000 or more, more preferably 5,000 or more, and still more preferably 10,000 or more. As the average molecular weight of a water soluble polymer is increased, the formation of a hydrophilic membrane which is effective for reducing haze on the surface of a wafer is more facilitated, and as a result, haze observed on the surface of a wafer after being polished is reduced. In this regard, when the average molecular weight of a water soluble cellulose contained in a polishing composition is 300,000 or more, more specifically 600,000 or more, and still more specifically 900,000 or more, haze observed on the surface of a wafer after being polished with the polishing composition is reduced to an especially preferable level for practical use. Likewise, when the average molecular weight of a vinyl polymer contained in a polishing composition is 1,000 or more, more specifically 5,000 or more, and still more specifically 10,000 or more, haze observed on the surface of a wafer after being polished with the polishing composition is reduced to an especially preferable level for practical use.

In the case where a water soluble polymer contained in a polishing composition is a water soluble cellulose, the average molecular weight of the water soluble cellulose used is preferably 3,000,000 or less, more preferably 2,000,000 or less, and still more preferably 1,500,000 or less. On the other hand, in the case where a water soluble polymer contained in a polishing composition is a vinyl polymer, the average molecular weight of the vinyl polymer used is preferably 1,000,000 or less, more preferably 500,000 or less, and still more preferably 300,000 or less. As the average molecular weight of a water soluble polymer is decreased, the reduction of polishing rate of a wafer due to a hydrophilic membrane is more suppressed. In this regard, when the average molecular weight of a water soluble cellulose contained in a polishing composition is 3,000,000 or less, more specifically 2,000,000 or less, and still more specifically 1,500,000 or less, the reduction of polishing rate due to a hydrophilic membrane is suppressed to an especially preferable level for practical use. Likewise, when the average molecular weight of a vinyl polymer contained in a polishing composition is 1,000,000 or less, more specifically 500,000 or less, and still more specifically 300,000 or less, the reduction of polishing rate due to a hydrophilic membrane is suppressed to an especially preferable level for practical use.

In the case where a water soluble polymer contained in a polishing composition is polyvinyl alcohol, the saponification value of polyvinyl alcohol used is preferably 75% or more, and more preferably 95% or more. As the saponification value is increased, the reduction of polishing rate of a wafer due to a hydrophilic membrane is more suppressed. In this regard, when the saponification value of polyvinyl alcohol contained in a polishing composition is 75% or more, and more specifically 95% or more, the reduction of polishing rate due to a hydrophilic membrane is suppressed to an especially preferable level for practical use.

An alkali contained in the polishing composition of the present embodiment may be, for example, either ammonia or an amine. These alkalis have the action to chemically polish a wafer, and serve to increase the rate of polishing a wafer by the polishing composition.

Ammonia and tetramethylammonium, from which metal impurities can be more easily removed compared with other alkalis, is easily highly purified. Therefore, an alkali contained in a polishing composition is preferably ammonia or tetramethylammonium.

The content of an alkali in a polishing composition is preferably 0.01 g/L or more, more preferably 0.02 g/L or more, and still more preferably 0.05 g/L or more. As the content of an alkali is increased, the rate of polishing a wafer by a polishing composition is more increased. In this regard, when the content of an alkali in a polishing composition is 0.01 g/L or more, more specifically 0.02 g/L or more, and still more specifically 0.05 g/L or more, the rate of polishing a wafer by the polishing composition is increased to an especially preferable level for practical use.

The content of an alkali in a polishing composition is also preferably 1 g/L or less, more preferably 0.5 g/L or less, and still more preferably 0.3 g/L or less. An alkali has possibility of causing an increase of surface roughness of a wafer after being polishing with a polishing composition. For this reason, as the content of an alkali in a polishing composition is decreased, an increase of surface roughness of a wafer after being polishing with the polishing composition is suppressed. In this regard, when the content of an alkali in a polishing composition is 1 g/L or less, more specifically 0.5 g/L or less, and still more specifically 0.3 g/L or less, an increase of surface roughness of a wafer after being polished is suppressed to an especially preferable level for practical use.

Abrasive grains contained in the polishing composition of the present embodiment may be, for example, silica such as powdered calcined silica, fumed silica, and colloidal silica. These abrasive grains have an action to polish a wafer mechanically, and serve to increase the rate of polishing a wafer by the polishing composition.

In the case where abrasive grains contained in a polishing composition are colloidal silica, the stability of a polishing composition is higher than in the case where other abrasive grains are used, resulting in the reduction of the number of LPDs on the surface of a wafer after being polished with the polishing composition. Colloidal silica used is preferably that which is synthesized by sol-gel method, in order to keep low the concentrations of sodium ions and acetate ions in a polishing composition. In sol-gel method, colloidal silica containing low amount of impurities is obtained by dissolving and hydrolyzing methyl silicate in a solvent consisting of methanol, ammonia, and water.

The content of abrasive grains in a polishing composition is preferably 0.01 g/L or more, more preferably 0.1 g/L or more, and still more preferably 0.2 g/L or more. As the content of abrasive grains is increased, the rate of polishing a wafer by the polishing composition is more increased. In this regard, when the content of abrasive grains in polishing composition is 0.01 g/L or more, more specifically 0.1 g/L or more, and still more specifically 0.2 g/L or more, the rate of polishing a wafer by the polishing composition is increased to an especially preferable level for practical use.

The content of abrasive grains in a polishing composition is also preferably 20 g/L or less, more preferably 10 g/L or less, and still more preferably 6 g/L or less. As the content of abrasive grains is reduced, the cost of a polishing composition is more reduced. In this regard, when the content of abrasive grains in a polishing composition is 20 g/L or less, more specifically 10 g/L or less, and still more specifically 6 g/L or less, the cost of the polishing composition is reduced to an especially preferable level for practical use.

The average primary particle diameter of abrasive grains contained in a polishing composition is preferably 10 nm or more, more preferably 15 nm or more, and still more preferably 20 nm or more. As the average primary particle diameter of abrasive grains in a polishing composition is increased, the action of abrasive grains to polish a wafer mechanically is strengthened, leading to increasing the rate of polishing a wafer by the polishing composition. In this regard, when the average primary particle diameter of abrasive grains is 10 nm or more, more specifically 15 nm or more, and still more specifically 20 nm or more, the rate of polishing a wafer by the polishing composition is increased to an especially preferable level for practical use.

The average primary particle diameter of abrasive grains contained in a polishing composition is also preferably 100 nm or less, more preferably 60 nm or less, and still more preferably 40 nm or less. Abrasive grains with a large average primary particle diameter have possibility of causing an increase of scratches on the surface of a wafer after being polished with a polishing composition. For this reason, as the average primary particle diameter of abrasive grains in a polishing composition is reduced, an increase of scratches on the surface of a wafer after being polished with the polishing composition is more suppressed. In this regard, when the average primary particle diameter of abrasive grains is 100 nm or less, more specifically 60 nm or less, and still more specifically 40 nm or less, an increase of scratches on the surface of a wafer after being polished is suppressed to an especially preferable level for practical use.

According to the present embodiment, the following advantages are obtained.

In the polishing composition of the present embodiment, the concentrations of sodium ions and acetate ions are 10 ppb or less. For this reason, by the polishing composition of the present embodiment, the occurrence of surface defects due to sodium ions and acetate ions in the polishing composition is strongly suppressed, and the number of LPDs with a size of 65 nm or more on the surface of a wafer is reduced.

The embodiment described above may be modified in the following manner.

While the concentrations of sodium ions and acetate ions in the polishing composition of the above embodiment are 10 ppb or less, it is also acceptable that the concentration of only one of either sodium ions or acetate ions is 10 ppb or less. In this case also, the occurrence of surface defects due to either sodium ions or acetate ions is strongly suppressed, and the number of LPDs with a size of 65 nm or more on the surface of a wafer is reduced.

Although the polishing composition of the above embodiment substantially consists of a water soluble polymer, an alkali, abrasive grains, and water, the constitution of the polishing composition may be optionally altered, with proviso that the concentrations of sodium ions and acetate ions are 10 ppb or less or the concentration of one of either sodium ions or acetate ions is 10 ppb or less. For example, a polyalkylene oxide such as polyethylene oxide and polyoxyethylene alkyl ether may be added to the polishing composition of the above embodiment according to necessity. Alternatively, a known additive such as a chelating agent, a surfactant, an antiseptic agent, an antifungal agent, and a rust inhibitor may be added.

The polishing composition of the above embodiment may be prepared by diluting a concentrated stock solution before use.

The polishing composition of the above embodiment may be used in polishing of physical objects other than semiconductor wafers.

Examples and Comparative Examples of the present invention will be described in the following.

The polishing compositions of Examples 1-7 and Comparative Examples 1-7 were prepared by properly mixing a water soluble polymer, an alkali, abrasive grains, and other components with water. The details of the water soluble polymer, alkali, abrasive grains, and other components in each polishing composition, as well as the concentrations of sodium ions and acetate ions in the polishing compositions are shown in Table 1.

In the column entitled “water soluble polymer” of Table 1:

HEC*¹ represents hydroxylethylcellulose subjected to cation exchange treatment and anion exchange treatment;

HEC*² represents hydroxylethylcellulose subjected to cation exchange treatment;

HEC*³ represents hydroxylethylcellulose subjected to anion exchange treatment;

HEC*⁴ represents hydroxylethylcellulose not subjected to cation exchange treatment and anion exchange treatment;

PVA*¹ represents polyvinyl alcohol subjected to cation exchange treatment and anion exchange treatment; and

PVA*² represents polyvinyl alcohol not subjected to cation exchange treatment and anion exchange treatment.

In the column entitled “alkali” of Table 1:

NH₃ represents ammonia;

TMAH represents tetramethylammonium hydroxide; and

PIZ represents anhydrous piperazine.

In the column entitled “abrasive grains” of Table 1:

CS*¹ represents colloidal silica with an average primary particle diameter of 35 nm.

In the column entitled “other component” of Table 1:

PEO represents poly(ethylene oxide); and

NaOH represents sodium hydroxide.

The concentrations of sodium ions in polishing compositions shown in the column entitled “sodium ion concentration” of Table 1 were measured using inductively coupled plasma-atomic emission spectroscopy (ICP-AES). The measurement of sodium ion concentration may be performed using inductively coupled plasma-mass spectrometry (ICP-MS) or atomic absorption spectrometer.

The concentrations of acetate ions in the polishing compositions shown in the column entitled “acetate ion concentration” of Table 1 were measured by capillary electrophoresis method.

The column entitled “LPDs” of Table 1 shows the results of measurement of the numbers of LPDs with a size of 65 nm or more on the surface of a silicon wafer after being polished with the polishing compositions of Examples 1-7 and Comparative Examples 1-7. Specifically, in the first place, a silicon wafer was preliminarily polished using GLANZOX-2100 made by Fujimi Inc. as a preliminary polishing composition under the polishing conditions shown in Table 2. Then, the silicon wafer after being preliminarily polished was finish polished using one of the polishing compositions of Examples 1-7 and Comparative Examples 1-7 as a finish polishing composition under the polishing conditions shown in Table 3. The wafer after being finish polished underwent SC-1 (Standard Clean 1) washing, followed by the measurement of the number of LPDs with a size of 65 nm or more per surface area of the wafer using “SURFSCAN SP1-TBI” made by KLA-Tencor Corporation.

The column entitled “haze” of Table 1 shows the results of measurement of haze level on the surface of a silicon wafer after being polished with each polishing composition of Examples 1-7 and Comparative Examples 1-7. Specifically, the wafer after being finish polished with one of the polishing compositions of Examples 1-7 and Comparative examples 1-7 underwent SC-1 washing, followed by the measurement of haze level on the surface of the wafer using “SURFSCAN SP1-TBI” made by KLA-Tencor Corporation.

TABLE 1

| | water soluble | | | | | | | | | | | |
|---|---|---|---|---|---|---|---|---|---|---|---|---|
| | polymer | | alkali | | abrasive grains | | other component | | sodium ion | acetate ion | | |
| | | content | | content | | content | | content | concentration | concentration | | |
| | name | [g/L] | name | [g/L] | name | [g/L] | name | [g/L] | (ppb) | (ppb) | LPDs | haze |
| Ex. 1 | HEC*¹ | 0.1 | NH₃ | 0.1 | CS*¹ | 5 | — | — | ≦1 | ≦5 | 20 | 0.06 |
| Ex. 2 | HEC*² | 0.1 | NH₃ | 0.1 | CS*¹ | 5 | — | — | ≦1 | 60 | 45 | 0.06 |
| Ex. 3 | HEC*³ | 0.1 | NH₃ | 0.1 | CS*¹ | 5 | — | — | 50 | ≦5 | 48 | 0.06 |
| Ex. 4 | HEC*¹ | 0.1 | TMAH | 0.1 | CS*¹ | 5 | — | — | ≦1 | ≦5 | 28 | 0.07 |
| Ex. 5 | HEC*¹ | 0.1 | PIZ | 0.1 | CS*¹ | 5 | — | — | ≦1 | ≦5 | 25 | 0.07 |
| Ex. 6 | HEC*¹ | 0.1 | NH₃ | 0.1 | CS*¹ | 5 | PEO | 0.05 | ≦1 | ≦5 | 22 | 0.04 |
| Ex. 7 | PVA*¹ | 0.1 | NH₃ | 0.1 | CS*¹ | 5 | — | — | ≦1 | ≦5 | 30 | 0.07 |
| C. Ex. 1 | HEC*⁴ | 0.1 | NH₃ | 0.1 | CS*¹ | 5 | — | — | 50 | 60 | 60 | 0.06 |
| C. Ex. 2 | HEC*⁴ | 0.1 | NH₃ | 0.1 | CS*¹ | 5 | NaOH | 0.001 | 600 | 60 | 97 | 0.06 |
| C. Ex. 3 | HEC*⁴ | 0.1 | NH₃ | 0.1 | CS*¹ | 5 | acetic | 0.001 | 50 | 750 | 103 | 0.06 |
| | | | | | | | acid | | | | | |
| C. Ex. 4 | HEC*⁴ | 0.1 | TMAH | 0.1 | CS*¹ | 5 | — | — | 50 | 60 | 65 | 0.07 |
| C. Ex. 5 | HEC*⁴ | 0.1 | PIZ | 0.1 | CS*¹ | 5 | — | — | 50 | 60 | 63 | 0.07 |
| C. Ex. 6 | HEC*⁴ | 0.1 | NH₃ | 0.1 | CS*¹ | 5 | PEO | 0.05 | 50 | 60 | 61 | 0.04 |
| C. Ex. 7 | PVA*² | 0.1 | NH₃ | 0.1 | CS*¹ | 5 | — | — | 400 | 150 | 121 | 0.07 |

TABLE 2
Conditions for preliminary polishing

polishing machine: “PNX-322” made by OKAMOTO MACHINE
TOOL WORKS, LTD.
polishing pad: “SUBA400” made by NITTA HAAS Incorporated.
polishing load: 15 kPa
rotational speed of platen: 30 rpm
polishing time: 3 min.
feed rate of polishing composition: 550 mL/min.
temperature of polishing composition: 20° C.
temperature of cooling water for platen: 23° C.
rotational speed of carrier: 30 rpm

TABLE 3
Conditions for finish polishing

polishing machine: “PNX-322” made by OKAMOTO MACHINE
TOOL WORKS, LTD.
polishing pad: “Surfin 000FM” made by FUJIMI INCORPORATED
polishing load: 15 kPa
rotational speed of platen: 30 rpm
polishing time: 4 min.
feed rate of polishing composition: 400 mL/min.
temperature of polishing composition: 20° C.
temperature of cooling water for platen: 23° C.
rotational speed of carrier: 30 rpm

As shown in Table 1, the result was obtained that the number of LPDs was reduced by means of a polishing composition of Examples 1-7 compared with the case by means of a polishing composition of Comparative Examples 1-7.

1. A polishing composition, comprising at least one of either sodium ions or acetate ions, wherein the concentration of one of either the sodium ions or acetate ions in the polishing composition is 10 ppb or less.

2. The polishing composition according to claim 1, further comprising a water soluble polymer, an alkali, and abrasive grains.

3. The polishing composition according to claim 2, wherein said water soluble polymer is hydroxyethylcellulose.

4. The polishing composition according to claim 2, wherein said alkali is ammonia.

5. The polishing composition according to claim 2, wherein said abrasive grains are colloidal silica.

6. A method of polishing, comprising polishing a surface of a semiconductor wafer using a polishing composition containing at least one of sodium ions or acetate ions, wherein the concentration of one of either the sodium ions or acetate ions in the polishing composition is 10 ppb or less.

7. A polishing composition comprising sodium ions and acetate ions, wherein the concentrations of sodium ions and acetate ions in the polishing composition are 10 ppb or less.

8. The polishing composition according to claim 7, further comprising a water soluble polymer, an alkali, and abrasive grains.

9. The polishing composition according to claim 8, wherein said water soluble polymer is hydroxyethylcellulose.

10. The polishing composition according to claim 8, wherein said alkali is ammonia.

11. The polishing composition according to claim 8, wherein said abrasive grains are colloidal silica.

12. A method of polishing, comprising polishing a surface of a semiconductor wafer using a polishing composition containing sodium ions and acetate ions, wherein the concentrations of sodium ions and acetate ions in the polishing composition are 10 ppb or less.
